(19) United States
(12) Patent Application Publication
(10) Pub. No.: US 2008/0302986 A1
(43) Pub. Date: Dec. 11, 2008

(54) METHOD AND APPARATUS FOR INJECTING ADDITIVES AND FOR SAFELY CALIBRATING ACCURACY OF A FLOW METER IN A CLOSED SYSTEM

(76) Inventors: Rick E. Leahy, Marshfield, MO (US); Peter S. Aswad, Spring, TX (US)

Correspondence Address: GORDON G. WAGGETT, P.C., 550 WESTCOTT STREET, SUITE 350, HOUSTON, TX, 77007-5099, US

(21) Appl. No.: 12/137,446

(22) Filed: Jun. 11, 2008

Related U.S. Application Data
(60) Provisional application No. 60/934,240, filed on Jun. 11, 2007.

(51) Int. Cl. F16K 31/02

(52) U.S. Cl. 251/129.01

(57) ABSTRACT

The present invention relates in general to a method and apparatus for blending several chemicals or fluids together. This invention also relates in general to a method and apparatus for safely calibrating a flow meter used for addition of liquid chemicals into other liquid chemicals in a closed system to minimize the environmental and occupational risks that may be associated with the added chemicals. In a preferred embodiment, a fluid injection system is provided with an in-line calibration device to permit calibration of the flow meter without introducing the fluid to the environment. In another embodiment, a preferred in-line calibration device is described that can be used to calibrate existing fluid additive injection systems. A method is disclosed for accurately and safely metering in additives to a desired location by employing a closed loop injection/calibration system.

### CROSS-REFERENCE TO RELATED APPLICATIONS

This application claims the benefit of the filing date of and priority to U.S. Provisional Application Ser. No. 60/934,240 entitled “Method and Apparatus for Injecting Additives and for Safely Calibrating Accuracy of a Flow Meter in a Closed System” and filed Jun. 11, 2007, Confirmation No. 8030. Said provisional application is incorporated by reference herein.

### STATEMENT REGARDING FEDERALLY SPONSORED RESEARCH OR DEVELOPMENT

Not Applicable.

### BACKGROUND OF THE INVENTION

This invention relates in general to a method and apparatus for blending several chemicals or fluids together. This invention also relates in general to a method and apparatus for safely calibrating a flow meter used for addition of liquid chemicals into other locations in a closed system to minimize the environmental and occupational risks that may be associated with the added chemicals.

A well-known and example application for additive injection systems is a truck loading terminal wherein tanker trucks are filled with fuel for transporting the fuel to a further distribution site. A tank on the truck is filled primarily with a generic fuel product from a fuel supply pipe. As the fuel is loaded into the tank, one or more fluid additives may be injected into the fuel stream to form a blended mixture of additive and the generic fuel product. The additive is typically injected into a fuel load arm connecting the fuel supply pipe to the fuel tank. The recipient of the shipment of fuel loaded into the tanker truck will often preselect the particular additive and specify the quantity (or ratio) of additive desired for the blended fuel. Consequently, the generic fuel may become the proprietary product of a fuel marketing company by blending a particular additive with the generic fuel in a specified ratio. Similarly, other systems exist wherein it is desired to add a measured quantity of one fluid into another location.

Additive injection equipment is used to meter an additive (such as a fuel additive) into something else (e.g., generic fuel). It is important to provide an accurate dosage of additive for each individual batch. This requires careful measurement of the additive as well as timely control of additive flow. Otherwise, the equipment may continue to inject additive (e.g., in the fuel example, into the load arm after the fuel stream has terminated). If so, not only will the most recent batch of fuel have a lower ratio of additive to fuel, but a subsequent batch of fuel may unintentionally flush the additive remaining in the load arm into the fuel tank on the truck. The presence of this extra additive in the subsequent batch of fuel will adversely affect the desired additive to fuel ratio for that batch, which may call for a different additive altogether. Likewise, in any system where one or more liquid additives is added, it can be highly important to accurately meter in the desired amount of additive.

Typically, the prescribed additive is incrementally blended into the fuel (or other product) stream at discrete intervals (or “pulses”) defined by a preselected ratio of fuel (or other product) to additive. For example, a particular order may require the injection of one gallon of additive into the load arm after 40 gallons of fuel have been supplied to the load arm. A fuel meter on the fuel supply pipe measures the fuel supplied to the load arm and sends pulses representing the quantity of fuel supplied to the additive injection equipment. Upon receiving a predetermined number of such pulses, the additive injection equipment supplies one gallon of additive to the load arm. Thus, the prescribed dose of additive is cyclically injected into the fuel stream based on the preselected ratio.

In an existing additive injection system, each chemical additive tank includes a control panel having a microprocessor, a solenoid valve and a flow meter. One additional control panel is required for each additional fuel load arm to which the additive tank is coupled for injecting additive therein. These control panels control the flow of additive into the load arm in response to pulses received from the fuel flow meter, the pulses representing the quantity of fuel passing through the supply pipe as described above.

Alternatively, the additive may be continuously fed into the fuel stream in accordance with a predetermined additive to fuel ratio. For continuous injection, the injection of additive commences shortly after fuel begins to flow through the supply pipe into the load arm. Throughout most of the fuel loading process, the proportion of additive to fuel supplied to the fuel tank substantially adheres to the established ratio. However, the rate of additive injection should drop off sharply just prior to the termination of fuel flow through the fuel supply pipe. Otherwise, the previously addressed problem of additive remaining in the fuel load arm may occur.

Additive injection equipment may also be used to inject certain additives into fuel or other tanks in a retail setting, such as a service station or other location. A service station may inject varying levels of additive from a single on-site additive tank into several fuel tanks to create different grades of gasoline. Typically, each fuel tank at a service station will be associated with its own fuel supply pipe. The additive tank may be individually coupled with each of the fuel supply pipes so that a desired quantity of additive can be blended with the fuel supplied to any one of the fuel tanks. Each of the fuel tanks at the service station is also associated with a separate fuel pump accessible to consumers. Thus, a consumer may individually select a particular grade of gasoline based on the relative quantity of additive contained in the fuel.

By contrast to the wholesale systems employed at truck loading terminals, retail systems typically do not inject additive at intervals in response to the flow rate of fuel into the fuel tank because the flow rates are generally too high for the control panels to measure the pulses. Rather, most retail systems employ a batch process for injecting a preselected quantity of additive into the fuel supply pipe based on the quantity of fuel to be loaded into the fuel tank. For retail applications, fuel and additive are usually manually injected into the fuel tank, but it is not uncommon for an operator to use a computer or microprocessor to indicate the desired quantity of additive or fuel to be loaded just prior to manual injection. In any event, current retail injection systems are generally time and labor intensive and do not provide the accuracy and efficiency of automated injection systems.

An additional problem associated with the additive injection systems of the prior art arises when additive tanks or pipes are exposed to freezing temperatures. In this event, the additive contained therein may become stratified, undermining the injection process. One solution to this problem is to add diluents to the additive, which often increases the expense of the additive. However, it is preferable to avoid the use of diluents and blend concentrated additive with the fuel.

Additionally, as set out in applicant's U.S. Pat. Nos. 5,944,074 and 5,868,177, both of which are incorporated herein by reference as if fully set out, there is disclosed a method and apparatus for injecting additives employing an interchangeable additive injection apparatus which provides a plurality of flow paths from one or more upstream additive tanks to one or more downstream fuel containers. A plurality of additive lines converge into an additive conduit at a manifold disposed within the apparatus. A plurality of valves associated with the additive lines are selectively opened and closed to isolate one of the flow paths. A metering device is disposed along the additive conduit for measuring the flow of additive therethrough. A reversible, multiple port housing surrounds at least the valves and manifold. In a forward orientation, a plurality of upstream ports are coupled to upstream additive tanks, and a downstream port is coupled to a fuel tank. By reversing the housing, the apparatus is placed in a reverse orientation wherein the upstream port is connected to an upstream additive tank and a plurality of downstream ports are connected to downstream fuel tanks. In either orientation, an expansion apparatus may be coupled to an expansion port on the additive injection apparatus to provide a number of additional ports and flow paths. A controller is coupled with the injection apparatus to monitor and control the associated pumps, valves and meters.

Other products exist in the marketplace to electronically control the injection of chemical additives. For example, Titan Industries, Inc. (Spring, Tex.) provides a single point injector marketed and sold under the tradename “PROPAC-3”. Also, Enraf Fluid Technology (Roswell, Ga.) provides an injector system having 6 individual injection units coupled with one controller marketed under the name “MINI-PAK 6”.

In the current practice, when one desires to calibrate the injector meter to ensure that the meter is accurately measuring the amount of chemical added, an operator will connect a quick-disconnect hose to the injector and then permit the injected chemical to flow out of the hose over a measured time interval into a beaker held by the operator. The amount of chemical collected in the beaker over a set period of time is thereby used as the calibration standard. This practice leaves the operator open to accidental chemical spills, overflowing of beaker, and exposure to chemical vapors or other contact with the chemical. This is particularly problematic when the chemical additive is hazardous and dangerous (i.e., poisonous, carcinogenic, flammable, etc.) As the operator completes the calibration(s) of a meter at one location, the collected chemical will typically be poured into a bucket and the bucket will be carried to the next meter to calibrate. Once all of the calibration is complete (oftentimes multiple samples of multiple meters), the bucket will be transported to an on-site waste collection location. Apart from the environmental issues associated with collecting chemical samples in an open beaker, the operator's reading of the amount of chemical collected in the beaker is subjective and prone to visual inaccuracies.

As such, there exists a need to provide a safe, closed system for calibrating the chemical injectors used to pump metered amounts of chemical. Furthermore, there exists a need to reclaim the additive collected for calibration to avoid the hazards and expenses associated with disposal. Also, there exists a need to have a chemical injection system which provides this closed calibration as a part of the injection system or as a modular add-on that can be used to retrofit existing injection systems.

Additionally, there exists a need to add the chemical additive in a continuous, rather than pulsed fashion.

### BRIEF SUMMARY OF THE INVENTION

In one preferred embodiment of the present invention, there is described a safe touch injector designed with safety in mind. This injector (which is based on existing injector technology) includes a new modification comprising a built-in calibration feature that allows the operator to calibrate the injector without having to touch the liquid additive or breathe any additive vapors. The calibrated cylinder displays accurate measurement of chemical additive. Internal check valves can be removed for cleaning or for replacement. There is no loss of additive because all of the liquid is in a closed loop which eliminates spills or exposure when properly installed. In a preferred embodiment, the collection cylinder is spring-loaded to return the additive to either the additive tank during operation of the additive system or additive line when the pump is turned off and the pressure is reduced.

For operators who have existing injectors but would like to take advantage of this safe touch technology, a calibration unit is provided that can be attached to existing injectors in order to enable use of the safe touch calibration technology. When installed properly, the calibration unit has a built-in calibration cylinder that provides extremely accurate, repeatable calibrations without having any harmful additive liquid or vapors affecting the user. Both the of the afore-mentioned product innovations eliminate exposure to harmful vapors and additive liquids by the user and surrounding environment during calibration. The calibration unit can be outfitted with any desired cylinder volume, and preferred cylinder sizes are 100, 200 and 350 mL.

In a preferred embodiment there is described a closed loop fluid additive injection and calibration apparatus providing at least one additive flow path between at least one upstream additive tank and at least one downstream receiving vessel, said apparatus comprising: an inlet for receiving a fluid additive; conduit for containing the additive in said apparatus; a control valve having a front port in fluid communication with said inlet and a rear port in fluid communication with said front port and exiting said control valve; a metering device having an entrance and an exit for measuring the flow of the additive therethrough coupled via said conduit to said valve control rear port; a 3-way valve in fluid communication at a first side with said metering device exit, said 3-way valve capable of being placed in a first flow position to direct the additive therethrough to a desired point of injection and a second flow position to direct the additive therethrough to a calibration port; a calibration cylinder containing a chamber for receiving the additive from said 3-way valve calibration port, said chamber having a sealed piston displaceable by the entrance of the additive into said chamber through a chamber entry port; said piston having a spring to resist such displacement and having a displacement indicator for determining the volume of the additive received into said chamber; said chamber having an exit port to discharge the additive from said chamber upon sufficient force from said spring to return said piston to its undisplaced position; and a check valve in said conduit located between said chamber exit port and said inlet to permit the additive exiting from said chamber to flow back toward said inlet. The displacement indicator can comprise a stem containing volumetric markings to visually indicate the volume of fluid entering the chamber by the displacement of the piston, or the piston's movement can be electronically monitored and measured and the displacement of the piston can be electronically displayed through suitable electronic interface (not shown). The control valve can comprise a solenoid valve. The 3-way valve can comprise a ball valve. The valves employed can be mechanically and/or electronically controllable. The closed loop fluid additive injection and calibration apparatus can be manually operated or configured for electronic operation and for computer assisted or automated control. The closed loop fluid additive injection and calibration apparatus may further comprise a strainer located in fluid communication between the apparatus inlet and the control valve front port.

In another preferred embodiment there is described a closed loop fluid calibration apparatus comprising: an inlet for receiving a fluid; conduit for containing the fluid said apparatus; a 3-way valve in fluid communication at a first side with said inlet, said 3-way valve capable of being placed in a first flow position to direct the fluid therethrough to a desired point of outside of said apparatus and a second flow position to direct the fluid therethrough to a calibration port; a calibration cylinder containing a chamber for receiving fluid from said 3-way valve calibration port, said chamber having a sealed piston displaceable by the entrance of the fluid into said chamber through a chamber entry port; said piston having a spring to resist such displacement and having a displacement indicator for determining the volume of the fluid received into said chamber; said chamber having an exit port to discharge the fluid from said chamber upon sufficient force from said spring to return said piston to its undisplaced position; and an exit valve in said conduit located in fluid communication with said chamber exit port. The closed loop fluid calibration apparatus inlet can receive fluid from any desired flow meter that is attached in fluid communication with the inlet. The 3-way valve can comprise a ball valve. The valves employed can be mechanically and/or electronically controllable. The closed loop fluid calibration apparatus can be manually operated or configured for electronic operation and for computer assisted or automated control.

The present invention also pertains to a closed loop method of calibrating a fluid additive injection system comprising the steps of: diverting additive flow from the closed fluid additive injection system for a predetermined length of time into a closed loop side stream in fluid communication with a calibration cylinder containing a chamber, said chamber having a sealed piston displaceable by the entrance of the additive into said chamber through a chamber entry port; said piston having a spring to resist such displacement and having a displacement indicator for determining the volume of the additive received into said chamber; said chamber having an exit port to discharge the additive from said chamber upon sufficient force from said spring to return said piston to its undisplaced position; determining from the displacement indicator the volume of additive received into said chamber during said length of time; rediverting the fluid collected in said chamber into back into the closed fluid additive injection system; and performing any necessary adjustments to the fluid additive injection system based on the measurements made during the calibration step. The closed loop method of calibrating the fluid additive injector system can be performed manually, electronically, and/or automatically via computer process control.

### BRIEF DESCRIPTION OF THE SEVERAL VIEWS OF THE DRAWINGS

FIG. 1 shows a flow schematic diagram of a closed loop injection/calibration system according to a preferred embodiment of the present invention.

FIG. 2 shows a cross-sectional side view of a closed loop injection/calibration system according to a preferred embodiment of the present invention.

FIG. 2A shows a perspective view of a closed loop injection/calibration system according to a preferred embodiment of the present invention.

FIG. 3 shows a top cross-sectional view of a closed loop injection/calibration system according to a preferred embodiment of the present invention.

FIG. 3A shows an end view of the right side of the closed loop injection/calibration system depicted in FIG. 3.

FIG. 4 shows a side view of a calibration cylinder with calibration stem extended according to a preferred embodiment of the present invention.

FIG. 5 shows a flow schematic diagram of a closed loop calibration system according to a preferred embodiment of the present invention.

FIG. 6 shows a side cross-sectional view of a closed loop calibration system according to a preferred embodiment of the present invention.

FIG. 6A shows a perspective view of a closed loop calibration system according to a preferred embodiment of the present invention.

FIG. 7 shows a side cross-sectional view of the return port and associated valve employed in a closed loop calibration system according to a preferred embodiment of the present invention.

FIG. 8 shows a top cross-sectional view of a closed loop calibration system according to a preferred embodiment of the present invention.

FIG. 8A shows a side cross-sectional view of a closed loop calibration system according to a preferred embodiment of the present invention.

It will be appreciated that the foregoing drawings illustrate only certain embodiments of the invention and that numerous other variations may be created within the scope of the described invention.

### DETAILED DESCRIPTION OF THE INVENTION

The above general description and the following detailed description are merely illustrative of the subject invention and additional modes, advantages and particulars of this invention will be readily suggested to those skilled in the art without departing from the spirit and scope of the invention.

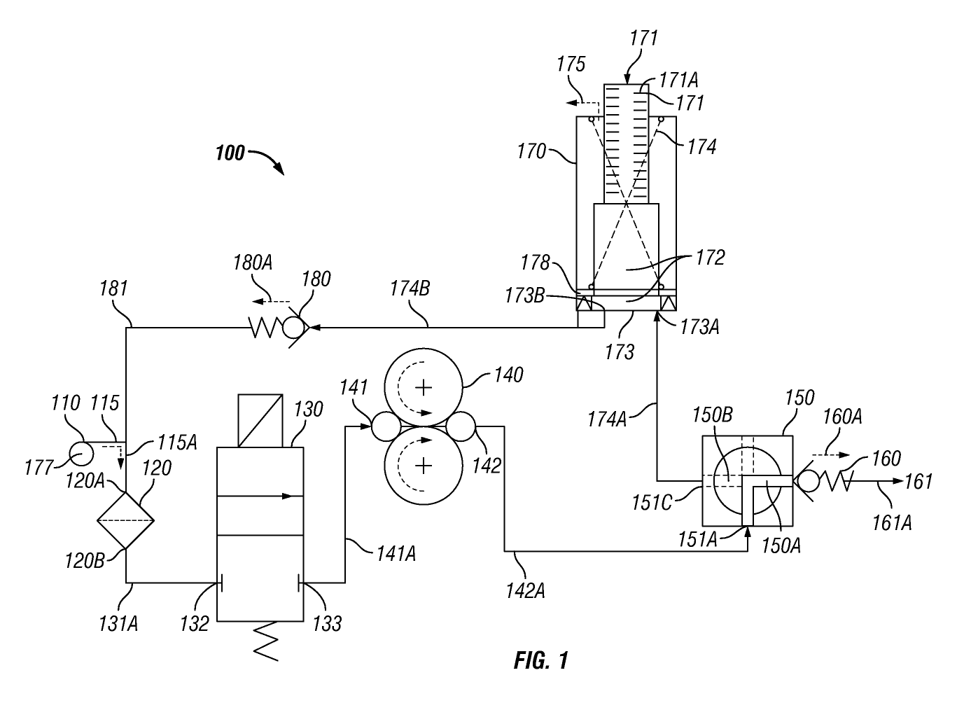

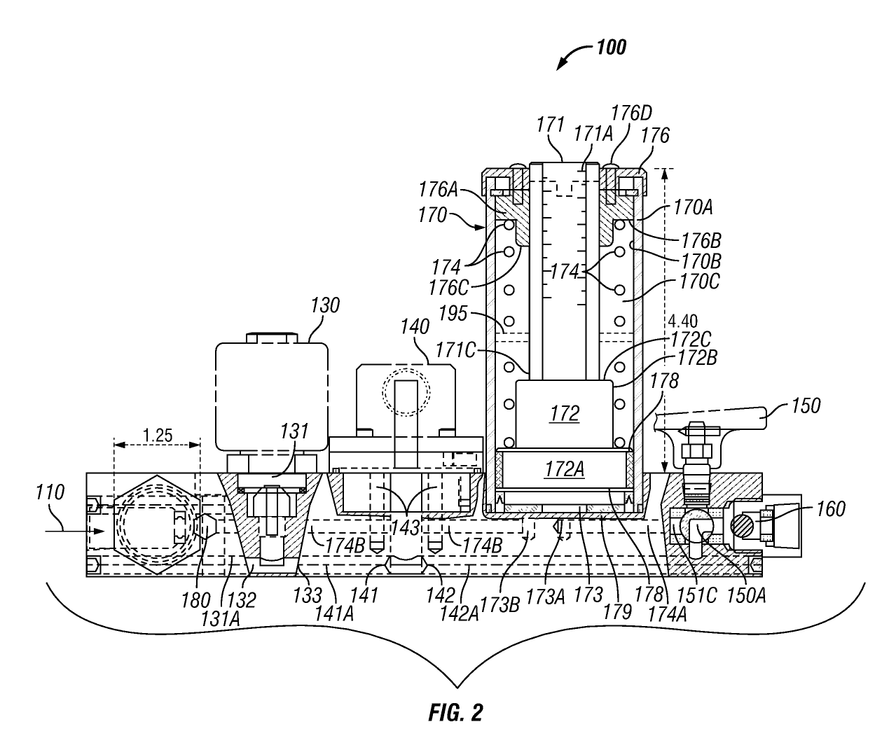

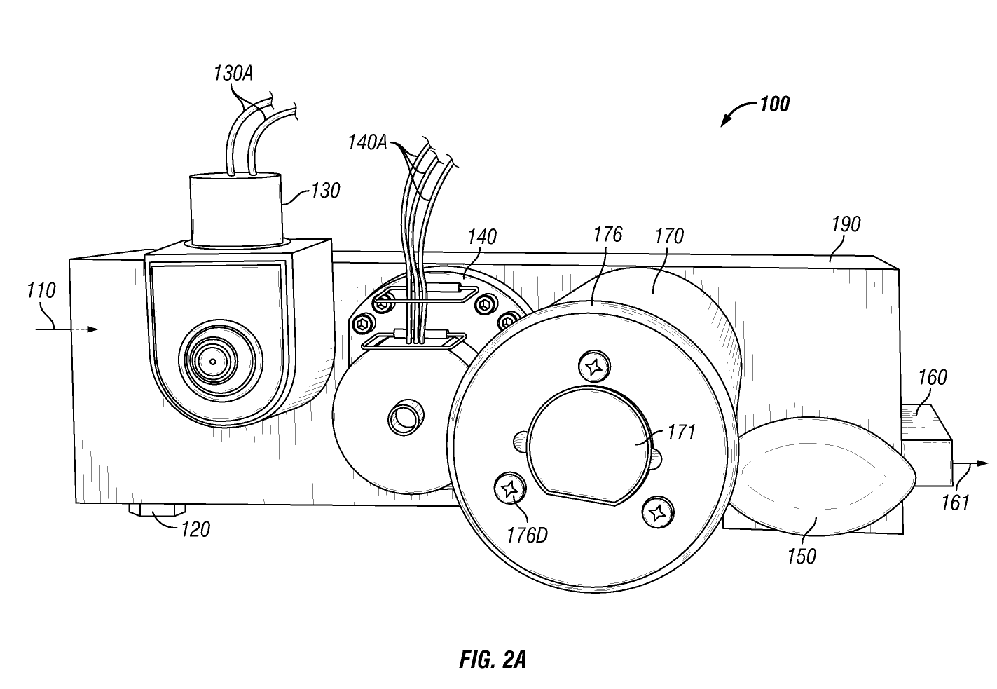

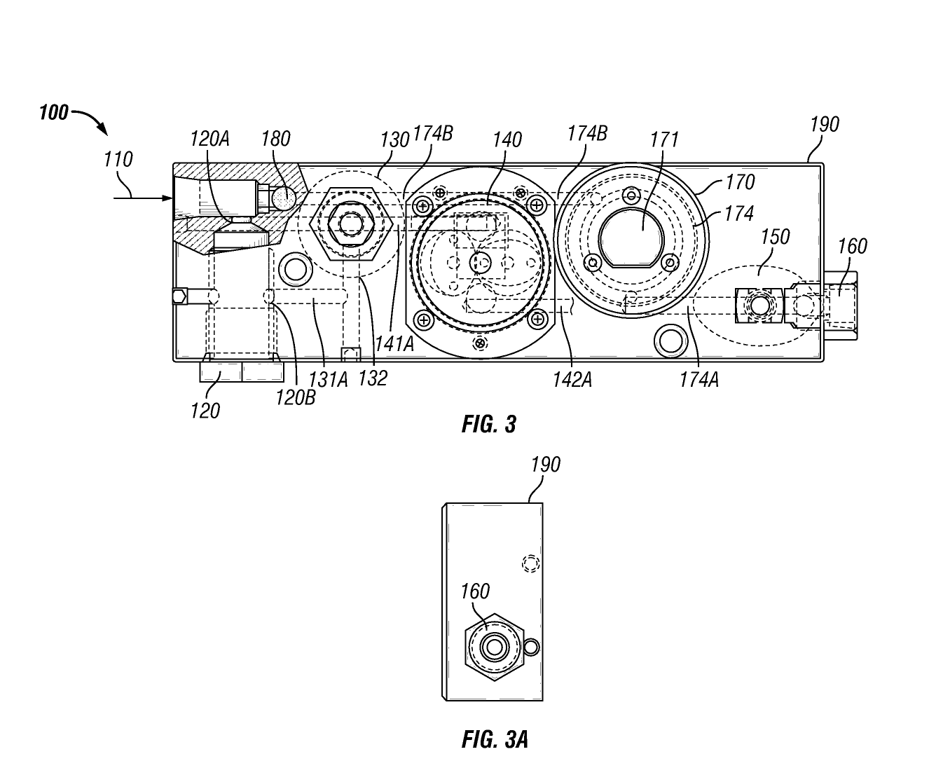

Referring now to FIGS. 1-4, there is depicted a preferred closed loop injection/calibration system 100. In FIG. 1, there is depicted an exemplary flow schematic illustrating operation of a preferred closed loop injection/calibration system 100. System inlet port 110 (such as a ⅜ NPTF inlet port) receives a desired fluid additive 177, such as a chemical additive, which is then preferably directed through suitable conduit 115 to a strainer 120 used to capture debris that may be present in the fluid 177. If a strainer is employed, the fluid 177 is pumped via pump (not shown) through system inlet conduit 115, through strainer inlet conduit 115a, through strainer inlet 120a, through strainer 120, and out strainer outlet 120b into valve inlet conduit 132a through control valve inlet or front port 132 and into control valve 130. The inlet strainer has a cavity with a stainless steel cover and Viton® fluoroelastomer o-ring. A replaceable stainless steel mesh strainer can be placed within the cavity. If a strainer is not employed, the fluid 177 is pumped through the system inlet conduit 115 through valve inlet conduit 132a through control valve inlet 132 and into control valve 130. The flow of the additive is stopped and regulated by a valve 130, such as a control valve or a solenoid valve which is controlled or regulated by a computerized automation process control system (not shown) known in the art. The solenoid or control valve 130 (such as, for example, the Skinner 7121 Series 2-way direct acting solenoid valves made by Parker Fluid Control, New Britain, Conn. and other valves known in the art) can be outfitted with replaceable orifices 131 known in the art depending on whether it is desired to have the valve operate in pulsed or continuous mode. The valve 130 (with its electronic interface 130a) regulates the flow of additive permitted to flow through a flow meter 140, such as the flow meters known in the art. Different gear sets known in the art (not shown) can be mounted on the meter pivot pins 143 to create different flow. The fluid 177 exits the control valve 130 through the control valve outlet or rear port 133, travels through the flow meter inlet conduit 141a, through the flow meter inlet or entrance 141 and into the flow meter 140. The flow meter 140 (with its electronic interface 140a) typically sends back signals to the control system to indicate, e.g., the number of rotations of the gears within the meter.

The additive 177 then proceeds through the flow meter 140, exiting flow meter outlet or exit 142, into flow meter outlet conduit 142a and into a 3-way directional valve 150 (which can be manually operated or electronically controlled) (such as those available from Hoke Incorporated, Spartanburg, S.C., including 3-way ball valves) capable of directing fluid therethrough in a first direction 150a through an exit check valve 160 (in the direction of flow indicated by arrow 160a) to the desired point of injection 161, such as pipeline (not shown), loading truck (not shown) or other suitable receiving vessel, etc. via suitable conduit 161a. When the 3-way valve 150 is in its first position 150a, fluid 177 can enter from flow meter outlet conduit 142a through valve inlet 151a and flow out of the valve outlet 151b toward the point of injection 161 via suitable conduit 161a. In this mode of operation, the flow path is bypassing the calibration system.

When fluid flow calibration is desired, the 3-way valve 150 is placed in a second position 150b, whereby the additive 177 is directed through valve inlet 151a and out of a second valve outlet 151c through cylinder inlet conduit 174a into a calibration cylinder 170 (through cylinder inlet or chamber entry port 173a) that forces upward movement of piston 172 as the fluid additive enters the cylinder fluid chamber 173. As the piston 172 moves upward, a calibration displacement indicator or calibration stem 171 will extend upward to indicate, via scored lines or other volumetric markings 171a (or electronic measurement and electronic display), the volume of fluid that has entered the cylinder fluid chamber 173 over a set period of time thereby permitting accurate and safe measurement of the received fluid 177 volume which in turn permits calibration of the control system (not shown) that controls the operation of, e.g., the solenoid valve 130. In a preferred embodiment of the spring return cylinder (or volume displacement accumulator) 170, the fluid chamber 173 has at least a 100 cc minimum volume, but other volumes are possible, including, for example, volumes of 200 cc and 350 cc and others. Ideally, the minimum chamber volume will be dictated by any standards or regulations required by regulatory agencies and the like to ensure that an appropriate amount of the fluid flow is actually obtained for each calibration test. The volumetric markings can be indicated in any desired increment, such as in 5 cc increments when the minimum volume is 100 cc, and can be laser cut into the face of the stem 171 or marked in any other suitable fashion known in the art. Also, suitable electronic measurement and display technology (not shown) known in the art could be employed to electronically read and display the volume displacement of the piston. In one embodiment, the cylinder return spring 174 is preferably rated to 60-120 lbs and requires a minimum 55 psi from the pump to fully extend the piston 172 against the force of the spring. Depending on the overall length of the cylinder 170 (i.e., between spring receiving shoulder 176d and the top of piston lower section 178, more than one spring may be required, in which case, one or more springs 174 may be stacked one on another with a suitable moveable divider or washer 195 placed therebetween. Although the spring 174 depicted in the drawings is shown axially surrounding the stem, other spring configurations could be employed, such as, for example, by placing a plurality of springs in space 170c (between the outside of the stem and the inside of the cylinder housing) extending between the receiving shoulder 176d and the top of lower piston section 172a.

The piston 172 comprises a lower piston section 172a that forms a sealed relationship with the cylinder outer housing 170a inner wall surface 170b. The shape of the piston 172 is designed to mirror the shape of the inside surface 170b of the cylinder outer housing 170a. The stem lower end 171c is mounted to the top of a base 172b located on the top of the piston 172. The top of the base forms a base upper shoulder 172c. Although the piston 172 is described with reference to individual structural features, such as, stem, stem lower end, base, shoulder, etc., the piston could be of unitary construction. As will be understood, the piston contains suitable seals/wear rings 178, such as might be made out of TEFLON® material to create the sealed relationship between the inside surface of the cylinder outer housing 170a and the outer surface of the piston lower section 172a. The seals 178, such as a spring seal, are contained in grooves (not shown) in the outer piston wall. The cylinder 170 also comprises a top housing 176a to hold the springs in place and an opening 171b to receive the stem 171. A cap 176 can also be used to cover the top of the cylinder (also being equipped with an opening to permit passage of the stem 171). The cap 176 can be secured to the top of the top housing 176a via fasteners/screws (such as button head screws 176d). The calibration cylinder preferable comprises an outer housing wall 170a of a substantially cylindrical shape (although the cylinder could also have other shapes). The cylinder 170 also has a cylinder top housing 176a attached to the top of the outer housing 170a and a lower housing 179 opposite the top housing also attached to the outer housing 170a. The underside of the top housing 176a is configured with a top housing shoulder 176b for receiving a spring 174, and a stop 176c for preventing further upward movement of the piston 172. The upward movement of the calibration piston 172 is resisted by the tension of the spring 174 that is mounted between the top housing shoulder 176b and the top of lower piston section 172a. The maximum potential upward movement of the piston 172 is reached when the upper shoulder 172c of base 172b contacts the stop 176c. After the calibration step of receiving fluid 177 into the cylinder fluid chamber 173 is completed, the 3-way valve 150 is returned to its first position 150a and the inlet 110 supply line pump (not shown) is turned off thereby relieving all upstream pressure which in turn permits the cylinder return spring 174 to force the piston 172 back to its starting position forcing the fluid additive 177 collected in the cylinder chamber 173 to exit cylinder outlet or chamber exit port 173b, through cylinder outlet conduit 174b past a cylinder check valve 180 (in the direction of flow indicated by arrow 180a) returning the additive fluid back to the inlet 110 (via return conduit 181) for reuse. Suitable venting 175 is employed to permit the passage of air in and out of the inner cylinder space 170c as the piston 172 moves up and down. In a preferred embodiment, the strainer 120, solenoid valve 130, flow meter 140, 3-way valve 150, exit check valve 160, calibration cylinder 170, and cylinder check valve 180 can be contained within or attached to a housing or body (manifold block) 190, which can be made of suitable materials, such as 6061 aluminum hardcoat anodized. In a preferred embodiment of the present invention, the check valves 180, 160 are replaceable. Thus, the flow paths defined by the conduits above, and their respective closed, fluid communication with each other, maintains the fluid 177 in a closed system within the injection/calibration system 100.

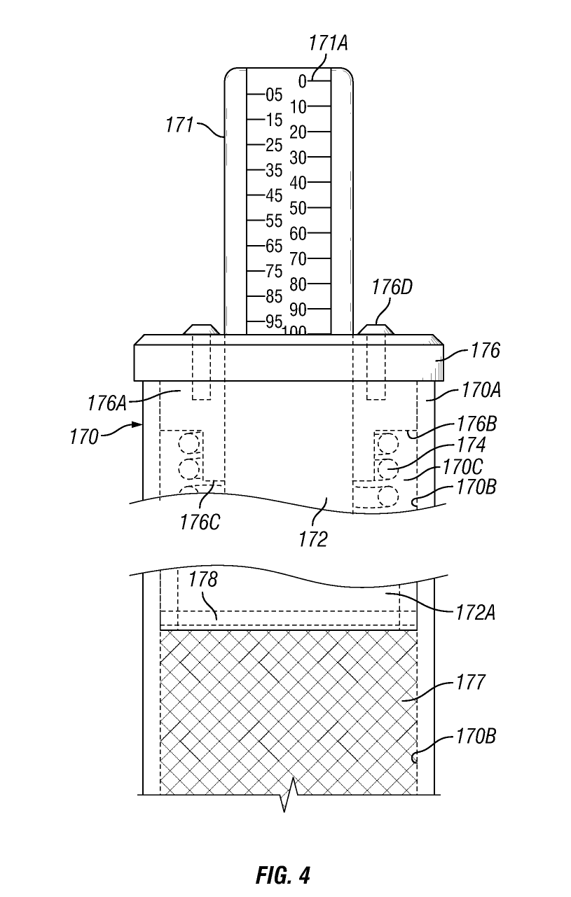

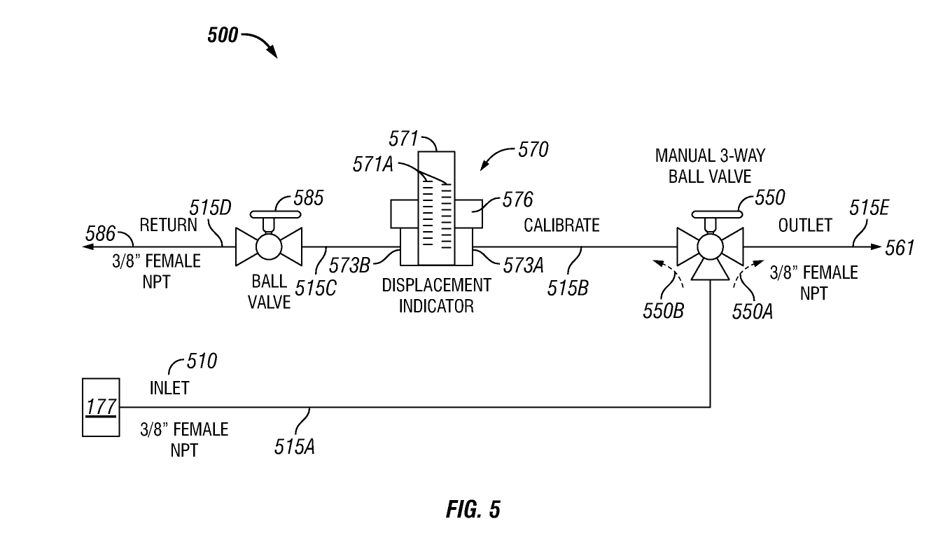

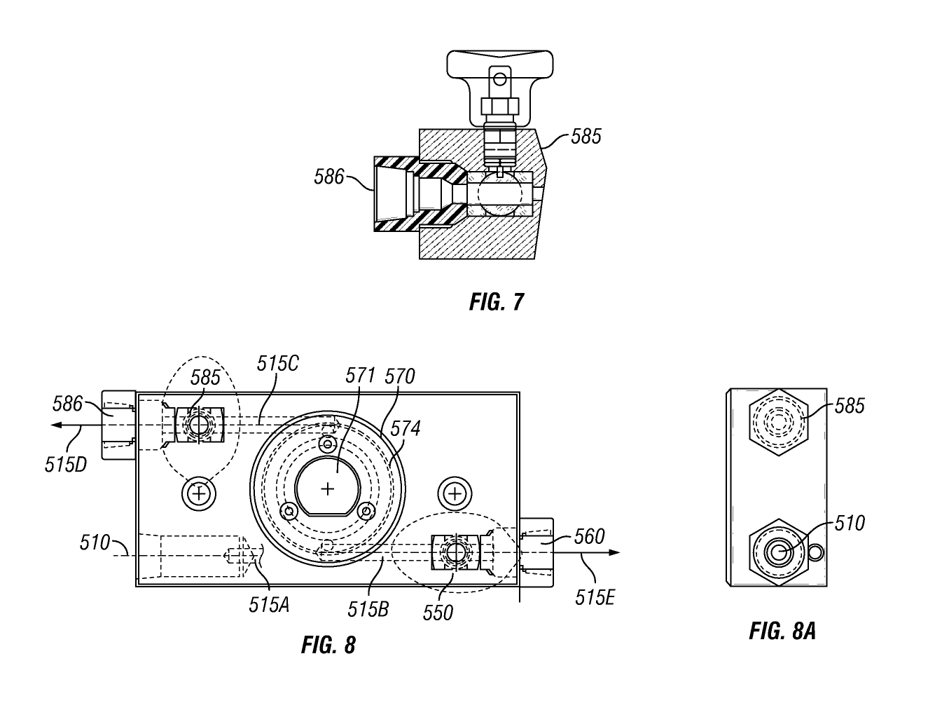

Referring now to FIGS. 5-8 (with reference also to FIG. 4), there is depicted a preferred closed loop calibration system 500. In FIG. 5, there is depicted an exemplary flow schematic illustrating operation of a preferred closed loop calibration system 500 that can be used with existing injection systems (not shown). Calibration system 500 is installed in-line into an existing additive injection system downstream of the injector. The closed loop system inlet 510 receives a desired fluid additive 177 from the fluid injector (not shown) into the closed system calibration inlet 510 (e.g., a ⅜″ female NPT). The fluid is then preferably directed through suitable closed loop system conduit 515a into a 3-way directional valve 550 (like the valve 150 described above)(which can be manually operated or electronically controlled) capable of directing fluid therethrough in a first direction 550a to the desired point of injection 561 via conduit 515e. In this mode of operation, the additive flow path is bypassing the added calibration system flow path.

When calibration of the fluid flow is desired, the 3-way valve 550 is placed in a second position 550b, wherein the additive 177 is directed through conduit 515b into a calibration cylinder 570 (like the cylinder 170 described above) (through cylinder inlet 573a) that forces upward movement of piston 572 (stem 571) as the fluid additive enters the cylinder fluid chamber 573. As the piston 572 moves upward, a calibration displacement indicator or calibration stem 571 will extend upward to indicate, via scored lines or other volumetric markings 571a (or suitable electronic interface), the volume of fluid that has entered the cylinder fluid chamber 573 over a set period of time thereby permitting accurate and safe measurement of the received fluid 177 volume which in turn permits calibration of the control system (not shown) that controls the operation of, e.g., the existing injector's meter (not shown).

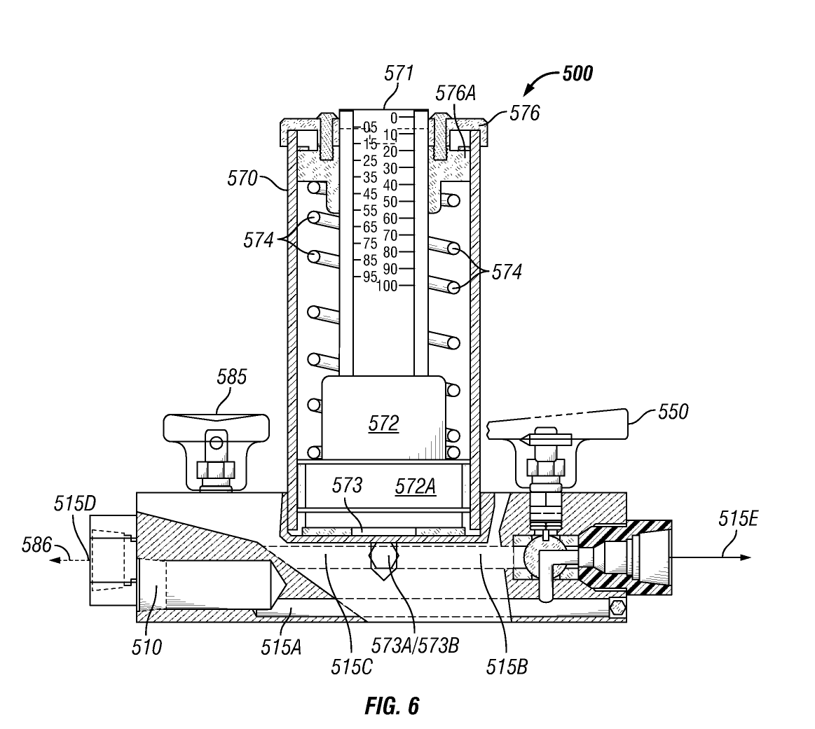

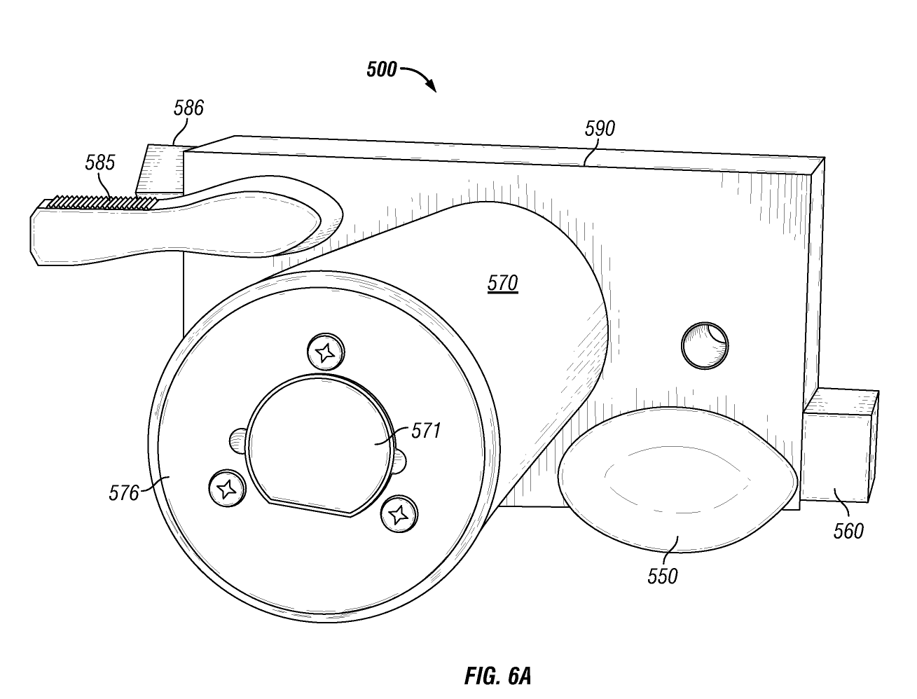

After the calibration step of receiving fluid into the cylinder chamber 573 is completed, the 3-way valve 550 is returned to its first position 550a and the inlet 510 supply line pump (not shown) is turned off thereby relieving all upstream pressure which in turn permits the cylinder return spring 574 to force the piston 572 back to its starting position forcing the fluid additive 177 collected in the cylinder chamber 573 to exit cylinder outlet 573b returning the additive fluid 177 back through conduit 515c to an outlet valve or exit valve 585 (such as a two-way ball valve offered by Hoke) which can then be directed to any desired location 586 via conduit 515d, such as, the existing chemical feed tank, etc. In a preferred embodiment, 3-way valve 550, exit valve 550 and calibration cylinder 570 can be contained within or attached to a housing or body 590. In the embodiment shown in FIG. 6, the cylinder inlet 573a and the cylinder outlet 573b are the same. When the pump is pumping fluid into the cylinder, the fluid enters through inlet 573a. When the pump is turned off, and the return line valve 585 is opened (and the three-way valve 550 is closed), the fluid in the cylinder chamber 573 can be pushed back out the outlet 573b down the return line 515d by virtue of the action of the spring 574. The inlet conduit 515a is in closed, fluid communication with additive 177 feed tank or pump (not shown) and the 3-way valve 550 inlet. When flow path 550a is used, the 3-way valve 550 is in closed, fluid communication, via conduit 515e, with the desired receiving vessel or place of injection 561, When the calibration step is employed, the 3-way valve 550 is in closed, fluid communication via conduit 515b with the entrance of calibration cylinder 570. The fluid collected in the calibration cylinder 570 can then be discharged via conduit 515c that is in closed, fluid communication with the entrance to valve 585, which in turn has its exit in closed, fluid communication, via return conduit 515d to, e.g., the additive tank (not shown). Thus, the operation of the calibration system 500 permits calibration of the fluid 177 without exposing the fluid to the outside environment.

The present invention also includes a preferred method of accurately and safely metering in additives to a desired location by employing a closed loop injection/calibration system of the present invention. There is further disclosed a preferred method of safely calibrating a fluid metering device without exposing the fluid to the environment by employing the closed loop calibration system of the present invention. There is also disclosed a method of retrofitting existing additive injection systems to add a closed loop calibration system of the present invention. For example, in operating a closed loop method of calibrating a fluid additive injection system according the present invention, additive flow from the closed fluid additive injection system is diverted for a predetermined length of time into a closed loop side stream in fluid communication with a calibration cylinder containing a chamber. The chamber has a sealed piston displaceable by the entrance of the additive into the chamber through a chamber entry port. The piston has a spring to resist such displacement and has a displacement indicator for determining the volume of the additive received into the chamber. The chamber has an exit port to discharge the additive from the chamber upon sufficient force from the spring to return the piston to its undisplaced position. From review of the displacement indicator, the volume of additive received into the chamber during the length of time can be determined. The fluid collected in the chamber can then be rediverted back into the closed fluid additive injection system. Any necessary adjustments to the fluid additive injection system can then be performed based on the measurements made during the calibration step. This methodology can be employed to conduct closed loop fluid calibration using the type of injector/calibration device 100 described above, or by introducing a closed loop calibration device 500 of the type described above into an existing fluid flow path downstream of the injector to permit closed loop calibration of the fluid flow through the injector.

While the present invention has been described in terms of preferred embodiments, it will be apparent to those of skill in the art that variations may be applied to the process and system described herein without departing from the concept and scope of the invention. All such similar substitutes and modifications apparent to those skilled in the art are deemed to be within the scope and concept of the invention. Those skilled in the art will recognize that the methodologies of the present invention have many applications, and that the present invention is not limited to the representative examples disclosed herein. Moreover, the scope of the present invention covers conventionally known variations and modifications to the system components described herein, as would be known by those skilled in the art. All such similar substitutes and modifications apparent to those skilled in the art are deemed to be within the scope and concept of the invention as it is set out in the following claims. For example, although some of the valve have been described as being manual operation, such valves could be substituted with electronically controllable valves, and the operation of the valves could be interfaced with the operation of the overall flow system, such as the flow meter using process control technology known in the art. The entire device could be configured to permit automated operation.

We claim:

1. A closed loop fluid additive injection and calibration apparatus providing at least one additive flow path between at least one upstream additive tank and at least one downstream receiving vessel, said apparatus comprising:
an inlet for receiving a fluid additive;
conduit for containing the additive in said apparatus;
a control valve having a front port in fluid communication with said inlet and a rear port in fluid communication with said front port and exiting said control valve;
a metering device having an entrance and an exit for measuring the flow of the additive therethrough coupled via said conduit to said valve control rear port;
a 3-way valve in fluid communication at a first side with said metering device exit, said 3-way valve capable of being placed in a first flow position to direct the additive therethrough to a desired point of injection and a second flow position to direct the additive therethrough to a calibration port;
a calibration cylinder containing a chamber for receiving the additive from said 3-way valve calibration port, said chamber having a sealed piston displaceable by the entrance of the additive into said chamber through a chamber entry port; said piston having a spring to resist such displacement and having a displacement indicator for determining the volume of the additive received into said chamber; said chamber having an exit port to discharge the additive from said chamber upon sufficient force from said spring to return said piston to its undisplaced position; and
a check valve in said conduit located between said chamber exit port and said inlet to permit the additive exiting from said chamber to flow back toward said inlet.

2. The apparatus of claim 1 wherein the control valve is a solenoid valve.

3. The apparatus of claim 1 wherein the 3-way valve is a ball valve.

4. The apparatus of claim 1 wherein the 3-way valve is electronically controlled.

5. The apparatus of claim 1 wherein the operation of the apparatus is electronically controlled.

6. The apparatus of claim 5 wherein the operation of the apparatus is computer controlled.

7. The apparatus of claim 1 further comprising a strainer located in fluid communication between said apparatus inlet and said control valve front port.

8. A closed loop fluid calibration apparatus comprising:
an inlet for receiving a fluid;
conduit for containing the fluid in said apparatus;
a 3-way valve in fluid communication at a first side with said inlet, said 3-way valve capable of being placed in a first flow position to direct the fluid therethrough to a desired point outside of said apparatus and a second flow position to direct the fluid therethrough to a calibration port;
a calibration cylinder containing a chamber for receiving fluid from said 3-way valve calibration port, said chamber having a sealed piston displaceable by the entrance of the fluid into said chamber through a chamber entry port; said piston having a spring to resist such displacement and having a displacement indicator for determining the volume of the fluid received into said chamber; said chamber having an exit port to discharge the fluid from said chamber upon sufficient force from said spring to return said piston to its undisplaced position; and
an exit valve in said conduit located in fluid communication with said chamber exit port.

9. The apparatus of claim 8 wherein the inlet receives fluid from a flow meter that is attached in fluid communication with the inlet.

10. The apparatus of claim 8 wherein the 3-way valve is a ball valve.

11. The apparatus of claim 8 wherein the 3-way valve is electronically controlled.

12. The apparatus of claim 8 wherein the operation of the apparatus is electronically controlled.

13. The apparatus of claim 12 wherein the operation of the apparatus is computer controlled.

14. A closed loop method of calibrating a fluid additive injection system comprising the steps of:
diverting additive flow from the closed fluid additive injection system for a predetermined length of time into a closed loop side stream in fluid communication with a calibration cylinder containing a chamber, said chamber having a sealed piston displaceable by the entrance of the additive into said chamber through a chamber entry port; said piston having a spring to resist such displacement and having a displacement indicator for determining the volume of the additive received into said chamber; said chamber having an exit port to discharge the additive from said chamber upon sufficient force from said spring to return said piston to its undisplaced position;
determining from the displacement indicator the volume of additive received into said chamber during said length of time;
rediverting the fluid collected in said chamber into back into the closed fluid additive injection system; and
performing any necessary adjustments to the fluid additive injection system based on the measurements made during the calibration step.

15. The closed loop method of claim 14 wherein said method is performed manually.

16. The closed loop method of claim 14 wherein said method is performed automatically via computer control.
